(19) United States
(12) Patent Application Publication
(10) Pub. No.: US 2007/0283372 A1
(43) Pub. Date: Dec. 6, 2007

(54) Adjusting Mechanism of Guide Rode for Optical Disk Drive

(75) Inventors: Min-Cheng Yang, Hsinchu (TW); Yuan-Yu Lee, Hsinchu (TW)

Correspondence Address: THOMAS, KAYDEN, HORSTEMEYER & RISLEY, LLP, 600 GALLERIA PARKWAY, STE 1500, ATLANTA, GA, 30339, US

(73) Assignee: LITE-ON IT CORPORATION, Taipei City (TW)

(21) Appl. No.: 11/532,129

(22) Filed: Sep. 15, 2006

(30) Foreign Application Priority Data
Jun. 2, 2006 (TW) 95119657

(51) Int. Cl. G11B 7/00

(52) U.S. Cl. 720/677

(57) ABSTRACT

The present invention discloses an adjusting mechanism of guide rod for an optical disk drive. The adjusting mechanism includes at least a guide rod for supporting an optical pickup head, an adjusting member and an elastic member. The adjusting member is set to be adjacent to the guide rod, and the elastic member provides elasticity to the guide rod to press the guide rod on a side surface of the adjusting member. The guide rod is moved to be close or away from a spindle motor by the adjusting member and in turn to adjust the off-center distance between the spindle motor and a laser beam emitted from the optical pickup head to improve the reading accuracy and efficiency of the optical pickup head.

### FIELD OF THE INVENTION

The present invention relates to an adjusting mechanism, and more particularly to an adjusting mechanism of guide rod for an optical disk drive.

### BACKGROUND OF THE INVENTION

The optical disk drive is widely used nowadays, and the optical disk is developed to have higher storage density than before. In order to read the data on the optical disk having high storage density, the reading accuracy of an optical pickup head in the optical disk drive must make progress to catch up with the rapid development of the optical disk.

Please refer to FIG. 1 and FIG. 2. FIG. 1 shows a perspective view of internal mechanism of a conventional optical disk drive and FIG. 2 shows a bottom view of internal mechanism of the conventional optical disk drive. The internal mechanism of conventional optical disk drive has a chassis 1. Two guide rods including a first guide rod 2 and a second guide rod 3 are disposed on the chassis 1. An optical pickup head 5 is slidably disposed on the first guide rod 2 and the second guide rod 3. The optical pickup head 5 is moved on the two guide rods by a stepping motor mounted on the chassis 1 so as to read an optical disk. Further, a spindle plate 6 for supporting a spindle motor 4 is disposed on the chassis 1 as shown in FIG. 2. The spindle motor 4 is used to support and rotate the optical disk.

Please refer to FIG. 3. FIG. 3 is a partially exploded view of an adjusting mechanism of the conventional optical disk drive. The adjusting mechanism is also disposed on the chassis 1 for supporting and adjusting the first and the second guide rods 2 and 3. The adjusting mechanism includes a screw 7 and a spring 8, and the end of the guide rod is clamped between the screw 7 and spring 8. The end of the guide rod is moved upward or downward by screwing the screw 7, and the height of the end of the guide rod depends on the depth of the screw 7 screwed into the chassis 1. Therefore, the adjusting mechanism adjusts the relative height between the end of the guide rod and the chassis 1. Consequently, the laser beam emitted from the optical pickup head 5, supported on the guide rod, is adjusted to be perpendicular to the data surface of the optical disk to improve the reading accuracy and efficiency of the optical pickup head 5.

However, the reading accuracy adjusted by the adjusting mechanism in the conventional optical disk drive is not enough to read the data on the optical disk having higher storage density. When reading the data on the optical disk having high storage density, the off-center distance between the spindle motor 4 and the laser beam plays an important role for correctly and efficiently reading the optical disk. The optical pickup head 5 would not correctly and efficiently read the optical disk if the off-center distance is not within the precision range. Thus the adjusting mechanism that only adjusts the tilt angle between the laser beam and the optical disk cannot satisfy the need of optical disk drive nowadays.

Therefore, the present invention is to find a way to adjust the position of the guide rod for overcoming the drawbacks of the conventional optical disk drive mentioned above.

### SUMMARY OF THE INVENTION

The object of the present invention is to provide an adjusting mechanism of guide rod for an optical disk drive. The adjusting mechanism adjusts the off-center distance between a spindle motor and a laser beam emitted from an optical pickup head to be within the precision range. Therefore, the reading accuracy and efficiency of the optical pickup head are improved.

According to the present invention, the adjusting mechanism of a guide rod for an optical disk drive is provided to include: a chassis, at least a guide rod, an adjusting member and an elastic member. The guide rod is disposed on the chassis for supporting an optical pickup head. The adjusting member is set to be adjacent to the guide rod, and the elastic member provides a force to the guide rod to press the guide rod on a side surface of the adjusting member.

As driving the adjusting member, the guide rod is moved to be close or away from a spindle motor for rotating and supporting an optical disk by contacting the side surface of the adjusting member. So that the off-center distance between the spindle motor and the laser beam emitted from the optical pickup head, supported on the guide rod, can be adjusted to be within the precision range. Therefore, the reading accuracy and efficiency of the optical pickup head are improved.

### BRIEF DESCRIPTION OF THE DRAWINGS

Other features and advantages of this invention will become more apparent in the following detailed description of the preferred embodiments of this invention, with reference to the accompanying drawings, in which:

FIG. 1 is a perspective view of internal mechanism of a conventional optical disk drive.

FIG. 2 is a bottom view of internal mechanism of the conventional optical disk drive.

FIG. 3 is a partially exploded view of an adjusting mechanism of the conventional optical disk drive.

FIG. 4 is a bottom view of internal mechanism of an optical disk drive of the present invention.

FIG. 5 is a partially exploded view of FIG. 4 showing an adjusting mechanism according to the first embodiment of the present invention.

FIG. 6A shows the relation between a cam and a guide rod according to the first embodiment of the present invention.

FIG. 6B is a sectional view of the cam along A-A line of FIG. 6A.

FIG. 7 is a perspective view of internal mechanism of an optical disk drive according to the second embodiment of the present invention.

FIG. 8 is a sectional view of an adjusting mechanism according to the second embodiment of the present invention.

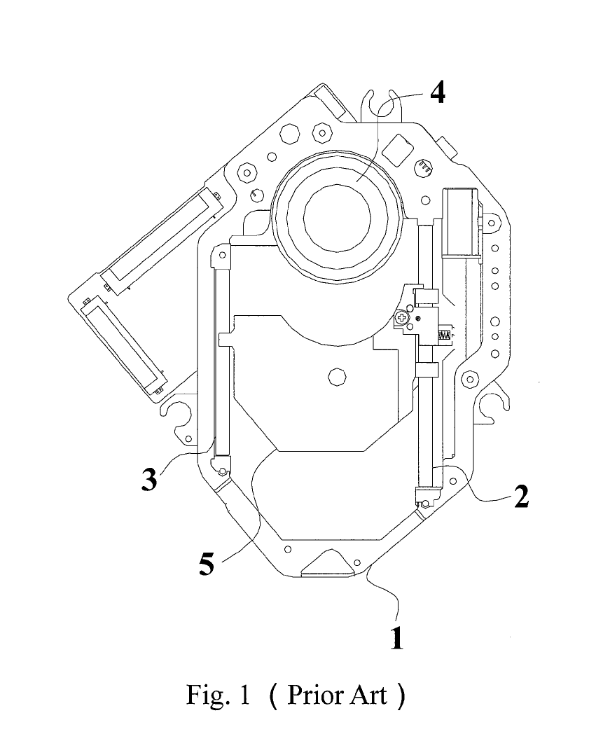

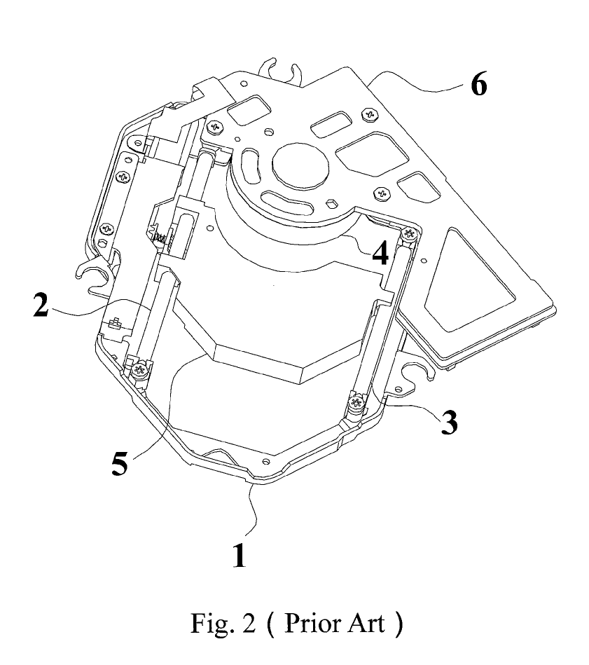

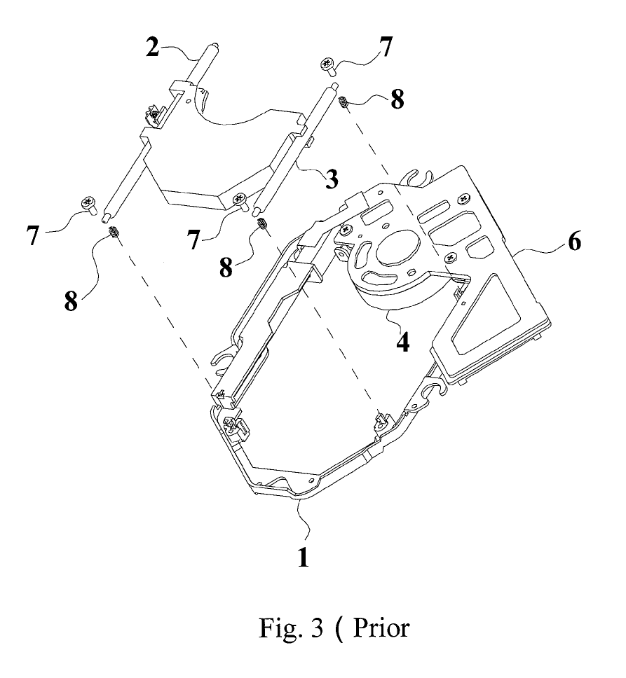

### DETAILED DESCRIPTIONS OF THE PREFERRED EMBODIMENT

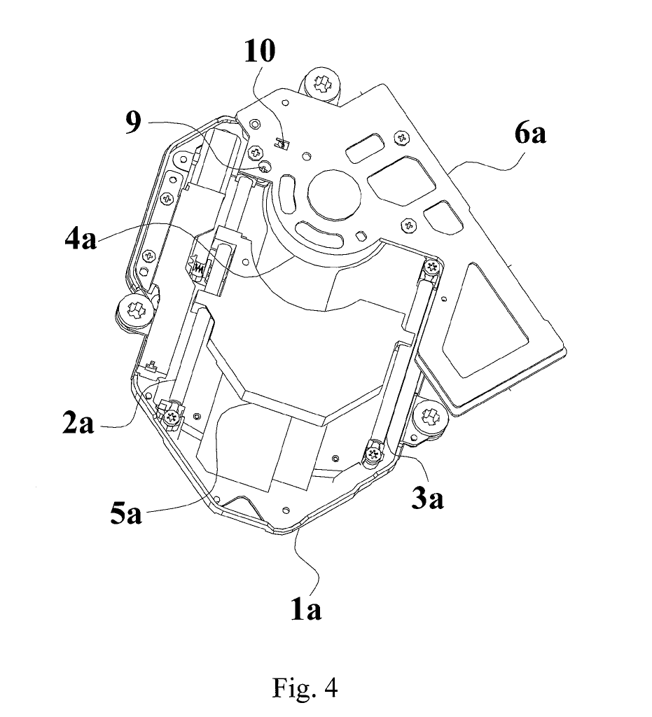

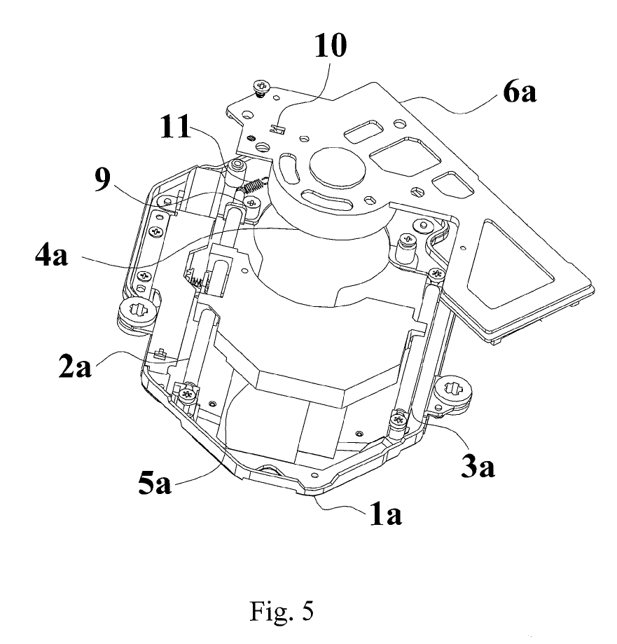

Please refer to FIG. 4 and FIG. 5. An internal mechanism of an optical disk drive according to the first embodiment of the present invention is presented in FIG. 4, and an adjusting mechanism is shown in FIG. 5.

The adjusting mechanism according to the first embodiment of the present invention includes a chassis 1a, at least a guide rod 2a, an adjusting member 9 and an elastic member 11 as shown in FIG. 5. The guide rod 2a is disposed on the chassis 1a for supporting an optical pickup head 5a. The adjusting member 9 in the preferred embodiment is a cam 9 set to be adjacent to the guide rod 2a, and the elastic member 11 provides elasticity to the guide rod 2a so that the guide rod 2a is pressed on the side curved surface of the cam 9.

In this embodiment, the guide rod 2a is a first guide rod 2a, and the optical disk drive further includes a second guide rod 3a. Both the first guide rod 2a and the second guide rod 3a are disposed on the chassis 1a for supporting the optical pickup head 5a. The optical pickup head 5a for reading an optical disk is slidably disposed on the first guide rod 2a and the second guide rod 3a. A stepping motor mounted on the chassis 1a is used to move the optical pickup head 5a on the two guide rods. Further, a spindle plate 6 for supporting a spindle motor 4a which is used to support and rotate the optical disk is disposed on the chassis 1a.

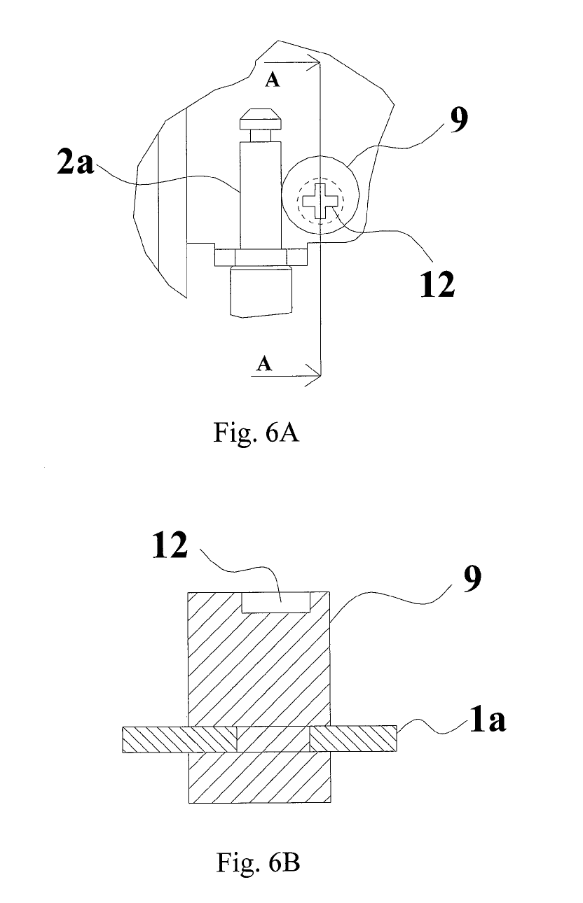

Please refer to FIG. 6A and FIG. 6B. FIG. 6A shows the relation between the cam 9 and the first guide rod 2a of the present invention. FIG. 6B is a sectional view of the cam 9 along A-A line of FIG. 6A.

In this embodiment, the cam 9 is an eccentric cam, but it also can be a pear-shaped cam or a cam having other shape. The cam 9 is disposed on the chassis 1a and is set to be adjacent to the first guide rod 2a by injection molding. A groove 12 is formed on the top of the cam 9. In this embodiment, the groove 12 is a cross-shaped groove 12. Therefore, the cam 9 is rotated by a cross-head screwdriver. The groove 12 is not limited to be the cross-shaped groove 12, but also can be a flat-shaped groove or other shapes.

The elastic member 11, such as a spring, a spring plate or other elements, provides elasticity to the first guide rod 2a. In this embodiment, the elastic member 11 is a spring 11 as shown in FIG. 5. The one end of the spring 11 is connected to a connecting element 10 disposed on the spindle plate 6a. The other end of the spring 11 is connected to the end of the first guide rod 2a. The spring 11 provides elasticity to the first guide rod 2a so that the first guide rod 2a is pressed on the side curved surface of the cam 9.

By rotating the cam 9, the first guide rod 2a is moved leftward or rightward by contacting the side curved surface of the cam 9. In other words, the first guide rod 2a is adjusted to be close or away form the spindle motor 4a. Therefore, the distance between the spindle motor 4a and the first guide rod 2a is adjusted by the adjusting mechanism of the present invention. Further, the off-center distance between the spindle motor 4a and the laser beam emitted from the optical pickup head 5a is adjusted to be within the precision range. Then, the reading accuracy and efficiency of the optical pickup head 5a can be improved.

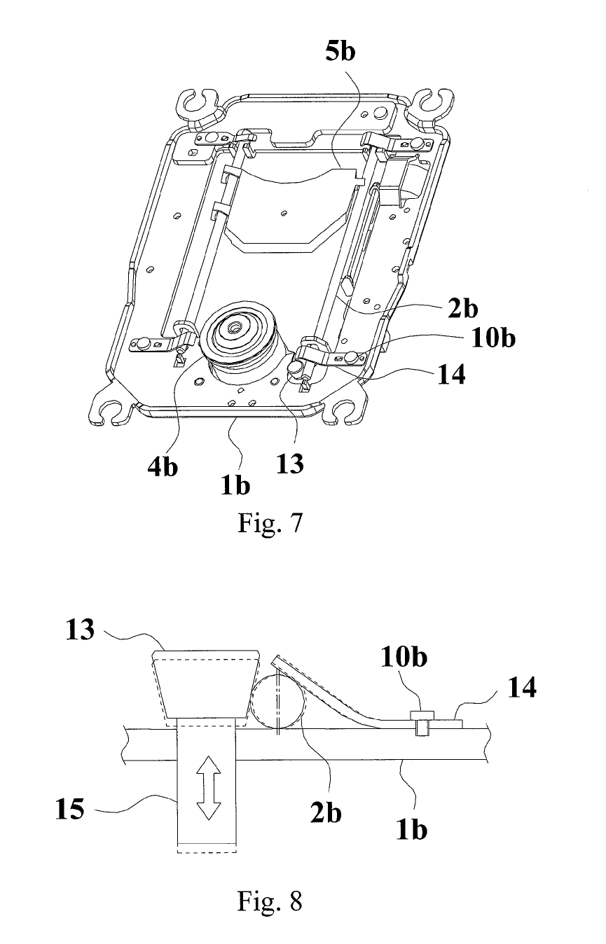

Please refer to FIG. 7 and FIG. 8. A perspective view of internal mechanism according to the second embodiment of the present invention is shown in FIG. 7. FIG. 8 shows a sectional view of an adjusting mechanism according to the second embodiment of the present invention.

In the second embodiment of the present invention, the adjusting mechanism is similar to the first embodiment. The adjusting mechanism according to second embodiment includes an adjusting member 13, an elastic member 14, a chassis 1b and a guide rod 2b disposed on the chassis 1b. In the second embodiment, the adjusting member 13 of the adjusting mechanism is a taper pillar 13. The taper pillar 13 is disposed adjacent to the first guide rod 2b and can be moved up and down. The elastic member 14 of the adjusting mechanism in this embodiment is a spring plate 14, but it can also be a spring. One end of the spring plate 14 is fixed on the chassis 1b by a connecting element 10b and the other end is pressed on the first guide rod 2b. The spring plate 14 provides elasticity to the first guide rod 2b so that the first guide rod 2b is pressed on the side surface of the taper pillar 13. The cross-section of the taper pillar 13 in the preferred embodiment is a circle. The taper pillar 13 can be a polygon having an inclined side surface.

In this embodiment, the taper pillar 13 has a protrusion 15 which is protruded from the bottom surface of the taper pillar 13. The protrusion 15 passes through a hole on the chassis 1b to dispose the taper pillar 13 on the chassis 1b. As moving the taper pillar 13 up or down, the first guide rod 2b is moved leftward or rightward by contacting the side surface of the taper pillar 13. In other words, the first guide rod 2b is adjusted to be close or away form a spindle motor 4b. Therefore, the distance between the spindle motor 4b and the first guide rod 2b is adjusted by the adjusting mechanism of the present invention. Further, the off-center distance between the spindle motor 4b and the laser beam emitted from the optical pickup head 5b is adjusted to be within the precision range. Then, the reading accuracy and efficiency of the optical pickup head 5b can be improved.

In summary, the adjusting mechanism according to the present invention can adjust the off-center distance between the spindle motor and the laser beam emitted from the optical pickup head for overcoming the drawbacks of the adjusting mechanism in the conventional optical disk drive. And the optical pickup head can read the optical disk more accurately and efficiently.

While the invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

I claim:

1. An adjusting mechanism of guide rod for an optical disk drive comprising:
a chassis;
at least a guide rod disposed on the chassis for supporting an optical pickup head;
an adjusting member disposed on the chassis and adjacent to the guide rod; and
an elastic member, wherein one end of the elastic member is connected to the guide rod and provides a force to press the guide rod against a side surface of the adjusting member,
wherein the guide rod is adjusted to near or away from a spindle motor by the adjusting member.

2. The adjusting mechanism as claimed in claim 1, wherein the side surface of the adjusting member is a curved surface.

3. The adjusting mechanism as claimed in claim 1, wherein the side surface of the adjusting member is an inclined surface.

4. The adjusting mechanism as claimed in claim 1, wherein the elastic member is a spring.

5. The adjusting mechanism as claimed in claim 1, wherein the elastic member is a spring plate.

6. The adjusting mechanism as claimed in claim 1, wherein the adjusting member is a cam.

7. The adjusting mechanism as claimed in claim 6, wherein the cam is disposed on the chassis by injection molding.

8. The adjusting mechanism as claimed in claim 6, wherein the cam is an eccentric cam.

9. The adjusting mechanism as claimed in claim 6, wherein the cam is a pear-shaped cam.

10. The adjusting mechanism as claimed in claim 6, wherein the cam having a groove formed on the top of the cam.

11. The adjusting mechanism as claimed in claim 10, wherein the groove is a cross-shaped groove.

12. The adjusting mechanism as claimed in claim 10, wherein the groove is a flat-shaped groove.

13. The adjusting mechanism as claimed in claim 1, wherein the other end of the elastic member is connected to a connecting element.

14. The adjusting mechanism as claimed in claim 13, wherein the connecting element is disposed on a spindle plate disposed on the chassis, and the spindle motor is disposed on the spindle plate.

15. The adjusting mechanism as claimed in claim 13, wherein the connecting element is disposed on the chassis.

16. The adjusting mechanism as claimed in claim 1, wherein the adjusting member is a taper pillar.

17. The adjusting mechanism as claimed in claim 16, wherein the cross-section of the taper pillar is a circle.

18. The adjusting mechanism as claimed in claim 16, wherein the cross-section of the taper pillar is a polygon.
